(19) United States
(12) Patent Application Publication
(10) Pub. No.: US 2022/0191670 A1
(43) Pub. Date: Jun. 16, 2022

(54) TRANSFERRABLE PERSONAL ELECTRONIC ASSEMBLY

(71) Applicant: Universal Physicians, LLC, North Canton, OH (US)

(72) Inventors: Andy C. Kutscher, Canton, OH (US); Joseph E. Frantz, Massillon, OH (US)

(73) Assignee: Universal Physicians, LLC, North Canton, OH (US)

(21) Appl. No.: 17/546,338

(22) Filed: Dec. 9, 2021

Related U.S. Application Data
(60) Provisional application No. 63/124,196, filed on Dec. 11, 2020.

(51) Int. Cl. H04W 4/90

(52) U.S. Cl. CPC H04W 4/90

(57) ABSTRACT

A transferrable personal electronic assembly is disclosed. The assembly is capable of being removed from a first internet-enabled device and being engaged with a second internet-enabled device. Specifically, the assembly capable of being disengaged from a cradle provided on a case for a first cell phone and being engaged in a cradle provided on another case for the same first cell phone or for a different second cell phone. The assembly is capable of being activated to generate and send an emergency signal to a remote emergency services dispatcher simply by depressing an emergency button provided on the assembly. The assembly enables establishment of two way communication with the dispatcher and may also enable two-way video communication through the camera and screen of the cell phone.

### CROSS REFERENCE TO RELATED APPLICATIONS

This application claims the benefit of U.S. Provisional Application Ser. No. 63/124,196, filed on Dec. 11, 2020; the disclosure of which is incorporated herein by reference.

### TECHNICAL FIELD

The present disclosure relates to a transferrable personal electronic assembly. More particularly, in one example, the present disclosure relates to a personal electronic assembly that is capable of being removed from a first internet-enabled device and being engaged with a second internet-enabled device. Specifically, the present disclosure relates to a personal electronic assembly that is capable of being disengaged from a cradle provided on a case for a first cell phone and being engaged in a cradle provided on another case for the same first cell phone or a different second cell phone.

### BACKGROUND

### Background Information

Cell phone usage is nearly ubiquitous in the world. A traditional smart phone has a tempered glass touch screen on one side. To wit, a traditional smart phone now costs about the same as a laptop computer. But, due to size, ease of portability, and location of the screen, is much more likely to break the screen on a smartphone as compared to a laptop.

As such, many users have taken to protecting their smartphones, investment, and information by utilizing a cell phone case. Typically, cell phone cases cover the rear of the phone, wrap around the sides of the phone, and extend for a short distance outwardly beyond the front of the phone, thus effectively recessing the screen somewhat. The cell phone case will provide some improved impact protection to the smartphone and because of the recessing of the screen, may also protect the screen from breakage. Some cell phone cases are expensive investments themselves due to peripherals associated with the cases. Some of these peripherals provided on cell phone cases may include but are not limited to, electronic cigarette and vaping accessories, housing additional batteries, including speakers, cosmetic accessories, and increased grip members.

### SUMMARY

Typically, all of currently known cell phone cases are built solely to be engaged with a particular model of cell phone. As such, when one needs to replace the cell phone or the cell phone case, the peripherals built into the cell phone case for that particular model of cell phone will no longer be available for use.

The present disclosure relates to a method and apparatus useful for transferring a peripheral from one cell phone case to another. A transferrable personal electronic assembly is disclosed. The assembly is capable of being removed from a first internet-enabled device and being engaged with a second internet-enabled device. Specifically, the assembly capable of being disengaged from a cradle provided on a case for a first cell phone and being engaged in a cradle provided on another case for the same first cell phone or for a different second cell phone. The assembly is capable of being activated to generate and send an emergency signal to a remote emergency services dispatcher simply by depressing an emergency button provided on the assembly. The assembly enables establishment of two way communication with the dispatcher and may also enable two-way video communication through the camera and screen of the cell phone.

In one aspect, an exemplary embodiment of the present disclosure may provide a case system comprising a body adapted to be engaged with an internet-enabled device; a cradle provided on the body; and an assembly selectively removably engageable with the cradle; wherein the assembly is actuatable to send an emergency signal to an emergency services dispatcher located remote from a user of the case system. In one embodiment, the Interne-enabled device may be a portable device, and the portable device may be one of a cell phone, a tablet, a smart watch, a Personal Digital Assistant (PDA), a laptop computer, an eBook reader, and a gaming console. In other embodiments, the portable device may be a smart TV or a household appliance. In one embodiment, the body is a case that may be configured to be engaged around at least a portion of an exterior surface of the Interne-enabled device. In one embodiment, the assembly may be electronically paired to the Interne-enabled device. In other embodiments, the assembly is a stand-alone device capable of generating and transmitting an emergency signal on its own, i.e., independent of the Interne-enabled portable device. In one embodiment, the assembly, when activated, may be operable to generate and send the emergency signal via a wireless network. In one embodiment, the assembly may include a depressible emergency button. In one embodiment, the assembly may include one or more of a microphone, a speaker, a multi-function button, and an indicator light.

In another aspect, an exemplary embodiment of the present disclosure may provide a method comprising engaging a first body with a first portable device; engaging an assembly with a first cradle provided on the first body; wherein the assembly is actuatable to send an emergency signal to a remote emergency services dispatcher; removing the assembly from the first cradle; providing a second cradle on a second body; and engaging the assembly with the second cradle.

In one embodiment, engaging the first body with the first portable device may include engaging the first body with an Interne-enabled first portable device. In one embodiment, the method may further comprise electronically pairing the assembly with the Interne-enabled first portable device. In one embodiment, the method may further comprising engaging the second body with an Interne-enabled second portable device. In one embodiment, the method may further comprise g electronically pairing the assembly with the Interne-enabled second portable device. In one embodiment, providing each of the Interne-enabled first portable device and the Interne-enabled second portable device comprises selecting one of a cell phone, a tablet, a smart watch, a Personal Digital Assistant (PDA), a laptop computer, an eBook reader, and a gaming console.

In one embodiment, engaging the first body with the first portable device may include covering at least a portion of an exterior surface of the first portable device with the first body. In one embodiment, engaging the second body with the second portable device may include covering at least a portion of an exterior surface of the second portable device with the second body. In one embodiment, the method may further comprise providing the second portable device in a different configuration from a configuration of the first portable device. In one embodiment, the method may further comprise connecting the assembly to the first portable device via a wired or wireless connection. In one embodiment, the method may further comprise connecting the assembly to the second portable device via a wired or wireless connection, depressing an emergency button provided on the assembly; and generating and sending the emergency signal to the remote emergency services dispatcher. In one embodiment, the method may further comprise actuating one or more of a microphone, a speaker, and an indicator light.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 is a rear, left side perspective view of a first embodiment of a case system in accordance with an aspect of the present disclosure, wherein the case system includes an emergency assembly, a cell phone case, and a cell phone.

FIG. 1A is an exploded rear, left side, perspective view of the case system of FIG. 1.

FIG. 2 is a rear, left side perspective view of a second embodiment of a case system in accordance with an aspect of the present disclosure, wherein the case system includes an emergency assembly, a cell phone case, and a cell phone.

FIG. 3 is a partially exploded rear, left side perspective view of the emergency assembly and cell phone case of the case system of FIG. 2.

FIG. 4 is a rear, left side perspective view of a third embodiment of a case system in accordance with an aspect of the present disclosure, wherein the case system includes an emergency assembly, a cell phone case, and a cell phone.

Similar numbers refer to similar parts throughout the drawings.

### DETAILED DESCRIPTION

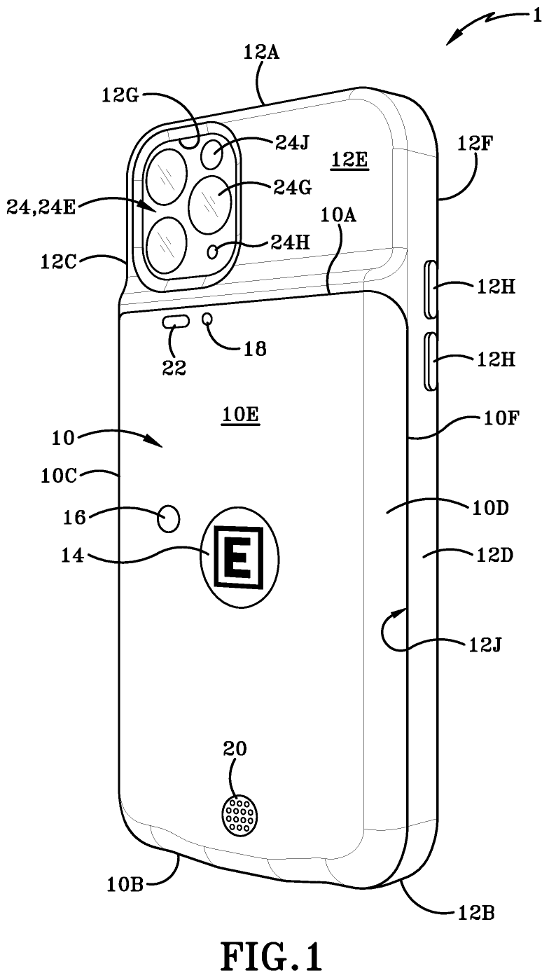

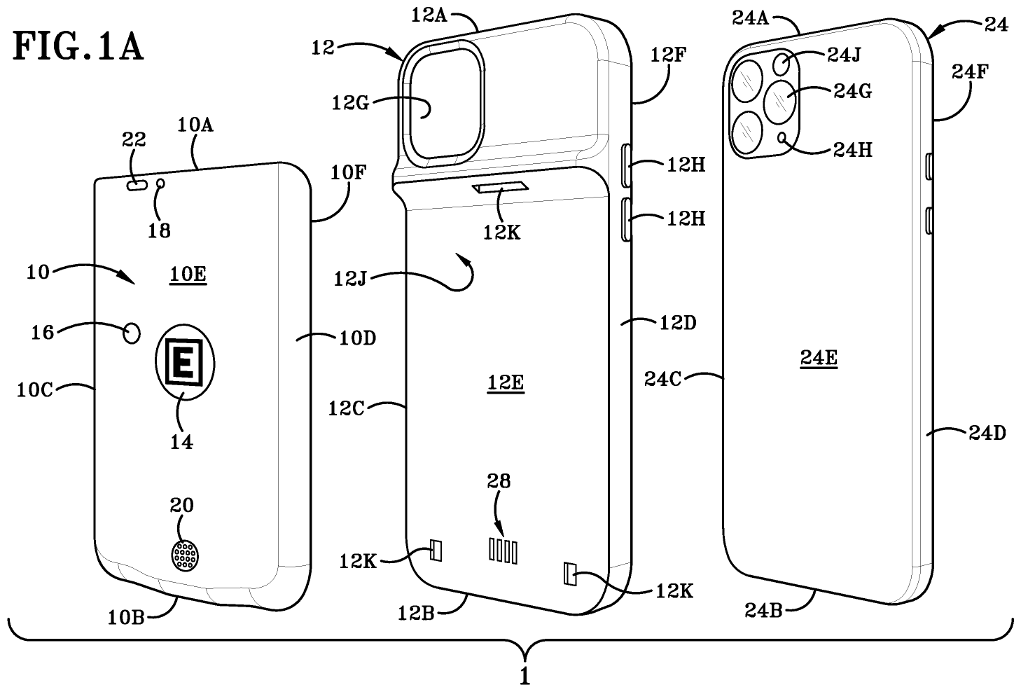

Referring to FIGS. 1 and 1A there is shown a first embodiment of a case system in accordance with an aspect of the present disclosure, generally indicated at 1. Case system 1 is comprised of an emergency assembly 10, a case 12, and a device 24. The device 24 is an internet-enabled device, i.e., a device that is capable of connecting to the internet. It is contemplated that device 24 is portable and may be any of a cell phone, a tablet, a smart watch, a Personal Digital Assistant (PDA), a laptop computer, an eBook reader, a gaming console. The attached figures show portable device 24 illustrated as a cell phone but it will be understood that the cell phone is exemplary of any other internet-enabled device which is portable.

As will be described hereafter, case 12 comprises a body or a housing that is configured to be engaged around at least a portion of an exterior surface of the portable device 24. Since portable device 24 is illustrated as a cell phone, the case 12 is configured to be complementary to the portable device 24 and, as a consequence, is illustrated as a cell phone case 12. It will be understood, however, that if portable device is a tablet or eBook reader or any other portable internet-enabled device, case 12 will be complementary in configuration to at least a portion of the exterior surface of that differently configured portable internet-enabled device.

Emergency assembly 10 is selectively detachably engageable with case 12 which in turn is selectively detachably engageable with cell phone 24. Emergency assembly 10 may also be referred to herein by the term “assembly 10”, cell phone case 12 may also be referred to herein by the terms “case 12”, “cover 12”, “body 12”, or “housing 12”; and the internet-enabled device 24 may also be referred to herein by the terms “portable device 24”, “device 24”, or “cell phone 24”. Each of the assembly 10, case 12, and cell phone 24 will be described in greater detail hereafter.

Referring to FIG. 1A, cell phone 24 comprises a first configuration of any known cell phone. Cell phone 24 includes a top 24A, a bottom 24B, a right side 24C, a left side 24D, a rear 24E and a front 24F. Top 24A is spaced apart from bottom 24B thereby defining therebetween a vertical direction. Right side 24C is spaced apart from left side 24D thereby defining therebetween a horizontal or transverse direction. Rear 24E is spaced apart from front 24F thereby defining therebetween the thickness of cell phone 24.

A screen (not shown) is provided as part of front 24F of cell phone 24. The screen may be a touchscreen that is usable as a Graphical User Interface (GUI) through which a user may operate the cell phone 24. The cell phone 24 may have various components provided thereon including, but not limited to, at least one rear facing camera 24G, at least one rear facing microphone 24H and at least one Light Emitting Diode (LED 24J. The cell phone 24 includes a plurality of operational components that are not numbered or are not illustrated in the attached drawings. These operational components may include, but are not limited to, On/Off buttons, volume control buttons, charging ports, multifunction buttons, a further microphone, a further speaker, at least one indicator light or additional LEDs, transceivers such as a BLUETOOTH® transceiver, and a variety of other components. (BLUETOOTH® is a registered trademark of BLUETOOTH SIG, INC. of Kirkland, Wash., USA.) All components of the cell phone 24 are well known in the art and therefore will not be further described herein safe as the components or the operation thereof pertains to the present disclosure.

As indicated earlier herein, case 12 is configured to be complementary to at least a portion of an exterior surface of the cell phone 24. Referring still to FIGS. 1 and 1A, case 12 has a top 12A spaced apart from a bottom 12B and defining therebetween a vertical direction. Case 12 has a right side 12C spaced apart from a left side 12D and defining therebetween a horizontal or transverse direction. Case 12 further includes a rear 12E spaced apart from a front 12F and defining therebetween the thickness of case 12. Case 12 may be ergonomically shaped along its top, bottom, and sides 12A, 12B, 12C, 12D so as to fit comfortably within a hand of a user.

It will be understood that case 12 is configured to wrap around an exterior surface of the rear 24E, top 24A, bottom 24B, right side 24C, and left side 24D of the complementary shaped cell phone 24, as is known in the art. Case 12 should therefore be considered as being exemplary of any cover or case for engagement with a particular configuration of cell phone 24, and the specific configuration of case 12 depicted in the attached drawings and described herein should not be considered as limiting the scope of the disclosure. Case 12 may include a plurality of projections and a plurality of recesses or apertures depending on the specific configuration of the cell phone 24 with which case 12 is to be engaged. As illustrated in FIGS. 1 and 1A, case 12 defines an aperture 12G that extends between rear 12E and front 12F. Aperture 12G is configured to be aligned with a region of cell phone 24 that includes the at least one rear facing camera 24G, the at least one rear facing microphone 24H, and the at least one LED 24J, when case 12 is engaged with cell phone 24. Case 12 further includes a plurality of projections 12H configured to be alignable with various buttons on the cell phone 24, such as the On/Off button and volume control button. Case 12 may further include other projections (not shown) which may comprise movable flaps configured to align with and selectively cover openings to components such as charging ports provided on the cell phone 24.

Case 12 may be fabricated from any suitable material including but not limited to plastics, metal, or some combination thereof and may include other additional materials as dictated by the desired implementation. According to one aspect, case 12 may be sealed or may otherwise include one or more gaskets or similar sealing surfaces that may allow case 12 to be water-resistant or waterproof to aid in protecting any internal electronic components of cell phone 24.

In accordance with an aspect of the present disclosure, case 12 is configured to form a cradle with which assembly 10 is selectively detachably engageable. The cradle, as illustrated in FIG. 1A, includes a recessed region 12J defined in rear 12E of case 12. Recessed region 12J is complementary in shape and size to assembly 10. The cradle also includes some type of mechanism for securing assembly 10 to case 12. By way of example only, the mechanism provided to secure assembly 10 to case 12 includes a plurality of apertures 12K defined in the rear 12E of case. Apertures 12K are located and configured so as to receive a plurality of projections (not shown) that extend outwardly from assembly 10. When the projections on assembly 10 are received in the apertures 12K, assembly 10 is interlockingly engaged with case 12. In other embodiments, interlocking ridges and grooves may be provided respectively, on case 12 and assembly 10 to allow assembly 10 to be slidably selectively removably engaged with case 12. It will be understood that any mechanism that enables assembly 10 to selectively removably engage with case 12 may be employed in case system 1. It will further be understood that the configuration of recessed region 12J and assembly 10 is exemplary only and any complementary configuration of these two components of case system 1 may be utilized. Case 12 (or assembly 10) may be sealed or may otherwise include one or more gaskets or similar sealing surfaces that may allow the interlocked assembly 10 and case 12 to be water-resistant or waterproof to aid in protecting any internal electronic components of assembly 10.

Assembly 10, as shown in FIG. 1A, is shaped to be complementary to the recessed region 12J of case 12. Assembly 10 includes a top 10A, a bottom 10B, a right side 10C, a left side 10D, a rear 10E, and a front 10F. In assembly 10, top 10A is spaced apart from bottom 10B defining therebetween a vertical direction, the right side 10C is spaced apart from a left side 10D defining therebetween a horizontal or transverse direction, and rear 10E is spaced apart from front 10F defining therebetween a thickness of the assembly 10.

Recessed region 12J of case is shown in FIG. 1A as including a wall located a short distance downwardly from aperture 12G. The wall is sloped at an angle and includes one of the apertures 12K for engagement of assembly 10. Top 10A of assembly 10 is complementary in slope so that when assembly 10 is engaged in the cradle of case 12, the angled wall of case 12 and top 10A of assembly 10 are in close abutting contact with one another. Sides 10C, 10D, and bottom 10B of assembly 10 are gently curved so that when engaged with case 12, the case 12 is ergonomic in configuration and comfortable for a user of the cell phone 24 to hold in their hand.

In accordance with another aspect of the present disclosure, assembly 10 includes an emergency button 14 that is operatively engaged with a variety of components housed within assembly 10. In particular, button 14 is provided on rear 10E of assembly 10 in a location which makes the button 14 readily accessible to the user. The button 14 may be formed of a rubberized or plastic material which imparts sufficient flexibility to the button 14 to allow depression thereof relative to rear 10E. When button 14 is depressed, an electronic circuit (not shown) within assembly 10 is closed and assembly 10 generates and sends an electronic signal to a remote emergency services dispatcher, as dictated by the desired implementation. Button 14 is configured to be sealed in order to impart additional water-resistant or waterproof properties to assembly 10.

Assembly 10 also includes a multifunction button 16, a microphone 18, a speaker 20, and an indicator light 22 that are all connected to a processor (not shown) via the electronic circuit in assembly 10. Assembly 10 is configured to generate and send an emergency signal to a remote emergency services dispatcher when button 14 is depressed. When button 14 is depressed and has sent the emergency signal, the microphone 18 and speaker 20 are activated to enable two-way communication with the remote emergency services dispatcher. Assembly 10 is configured to selectively electronically pair with the cell phone 24. When button 14 is depressed, assembly 10 is activated is operable to generate and send the emergency signal via a wireless network and may accomplish this by activating the cell phone 24. Assembly 10 may further activate the screen (not shown) on cell phone 24 when button 14 is depressed and thereby enable video communication with the remote emergency services dispatcher or other parties.

Multifunction button 16 may be, as the name implies, utilized to control multiple functions of assembly 10. For example, where no other buttons have been depressed, a brief depression of multifunction button 16 may provide a first function which may be, for example, a check of a battery provided in assembly 10. The battery in question may be a battery for operating assembly 10 on its own or the battery may provide power to assembly 10 and provide back-up power to cell phone 24 if needed. When the multifunction button 16 is depressed, an audible and/or visual indication may be provided to the user regarding the battery level, for example. The audible and/or visual indication may be delivered to the user via speaker 20 and/or indicator light 22, respectively. A longer depression and then a holding down of multifunction button 16 may provide a second function such as a resetting of assembly 10 or case system 1, or a reset of a memory of a processor provided in assembly 10. When emergency button 14 has been depressed but was depressed unintentionally or if the user wishes to cancel an emergency signal for another reason, the cancelation may be accomplished by depressing and/or pressing and holding multifunction button 16. This may cancel the emergency signal and any other related transmissions from assembly 10 or from cell phone 24. For example, depression of multifunction button 16 may cancel the transmission of a video signal and/or a text messaging signal from cell phone 24.

Microphone 18 may be a standard miniaturized microphone similar to those found in personal communications devices such as cell phones and other similar devices and may be integrated into assembly 10 in any suitable position or location as dictated by the desired implementation. Similarly, speaker 20 may be any miniaturized speaker 20 similar to those commonly used in electronic devices such as cell phones and the like and the speaker 20 may operate in a similar manner to speakers provided in cell phones, for example.

Indicator light 22 may be a miniaturized light emitting diode (LED) or the like similar to those used in other electronic equipment. The indicator light 22 may be operable to display one or more colored lights indicative of a mode of operation of assembly 10, or a charge status of a battery in assembly 10, or a connection or connectivity status for the assembly, or any other relevant information relating to the assembly 10 that is capable of being displayed and communicated by an illuminated light. As mentioned above, indicator light 22 on assembly 10 may be utilized to indicate a battery charge status. For example, a green indication from indicator light 22 may indicate a suitable charge while an orange or yellow light may indicate a low charge and a red light may indicate a critically low charge. These colors are exemplary only and are understood to be one manner in which indicator light 22 may be used, not as a limiting example thereof. Accordingly, it will be understood that the indicator light 22 may be of any color or color combination as desired and may be utilized to provide any desired visual feedback to a user of assembly 10. According to another aspect, indicator light 22 may be used to show that assembly 10 is powered on and active. According to yet another aspect, indicator light 22 may be used to indicate an active and open connection by assembly 10 to one or more of emergency services, a video contact, and/or a contact group. For example, a blinking light or a specific light color displayed by the indicator light 22 may be utilized to indicate a connection to emergency services while a different blinking pattern (e.g. a faster or slower blink, as desired) may indicate an active video connection to a video contact.

Having thus described the elements and components of case system 1, the operation and function thereof will now be discussed. With respect to FIG. 1B, the assembly 10 is shown disengaged from the case 12. When the user acquires a new cell phone 24, he or she will engage the case 12 with that cell phone 24 by deforming and manipulating the component regions of the case 12 so that the front 12F of the case 12 will abut the rear 24E of cell phone 24, and the top, bottom and sides 12A through 12D of case 12 will wrap around the top, bottom, and sides 24A through 24D of cell phone 24. Prior to or after engaging case 12 with cell phone 24, the assembly 10 will be engaged with case 12. This engagement is accomplished by placing assembly 10 in the cradle of case 12 and engaging the provided securement mechanism. For example, as illustrated in FIG. 1A, projections (not shown) on front 10F of assembly 10 will be interlockingly received within the apertures 12K on case 12. When assembly 10 is engaged with case 12, assembly 10 is paired with cell phone 24.

As described earlier herein, if an emergency occurs, the user of the cell phone 24 may depress the emergency button 14 on assembly 10, and thereby generate and send out an emergency signal to a remote emergency services dispatcher. The microphone 18 and speaker 20 will be actuated to enable two-way communication between the user of the cell phone 24 and the remote dispatcher. In some instances, the depressing of the emergency button 14 will activate the camera on the cell phone 24 and enable video communication between the user and another person, such as an emergency contact, located remote from the user. Alternatively, cell phone 24 may be activated to send out a group text to emergency contacts of the user.

If at a later time, the user changes their cell phone 24, provided the original case 12 fits the new cell phone, the user may keep the assembly 10 engaged with their original case 12, remove the combined assembly 10 and case 12 from the original cell phone 24, and then engage the original case 12 (with assembly 10 attached) on the new cell phone. If, however, the original case 12 does not fit the new cell phone, the assembly 10 may be disengaged from the original case 12 and be quickly and easily engaged with a new case. The new case will then be engaged with the new cell phone and the assembly 10 will then be paired with the new cell phone.

In a similar fashion, if the user simply wishes to change their original case 12 with a new case, the assembly 10 may be disengaged from the original case and be quickly and easily engaged with the new case. The new case will then be engaged with the original cell phone 24 and the assembly 10 will, once again, be paired with the original cell phone 24.

Thus, in accordance with another aspect of the present disclosure, a user may disengage assembly 10 from the cradle on the case 12 which surrounds the cell phone 24 and then engage the assembly 10 in a cradle of a different case which is to be engaged with cell phone 24. This may be done, for example, if the user wishes to change the case 12 for their cell phone. In other instances, the user may keep the assembly 10 engaged with the case 12 but then engaged that case with a different cell phone. In other instances, the user may engaged the assembly 10 with a different case that is engaged around a different cell phone. In this way, the user provides an emergency assembly on a different case for a same cell phone or on a different case for a different cell phone. It will be understood that in other instances, the assembly 10 may be engaged with a case for an internet-enabled device that is not a cell phone. For example, the assembly 10 may be engaged with a case for a tablet or an EBook reader.

When the assembly 10 is moved from the first case 12 on the first cell phone 24 to a second case or is effectively engaged with a second cell phone or a different internet-enabled device via the same case 12 or a different case, assembly 10 is connected to the first portable device (i.e., the first cell phone 24) via a wired or wireless connection or is connected to the second portable device (i.e., the second cell phone or other internet-enabled device) via a wired or wireless connection. When button 14 is subsequently depressed in an emergency, assembly 10 is electronically paired with the respective first cell phone 24, the second cell phone, or the other internet-enabled device. In other words, the assembly 10 comprises a portable peripheral (i.e., a personal electronic assembly) for internet-enabled devices that is able to be transferred from one internet-enabled device to another as desired by the user. It will be understood that various components on the cell phone, such as the camera 24G, microphone 24H, and the cell phones LED 24J, may all operatively interface with the assembly 10 through near field communication (NFC) or BLUETOOTH® communication, or through physical connection. These interfaced and operatively connected components allow assembly 10 to control and use the same as if they were an extension of the assembly 10 itself. Alternatively, in a further embodiment, the cell phone 24 may control the assembly 10 as if it were an extension of the assembly 10 itself.

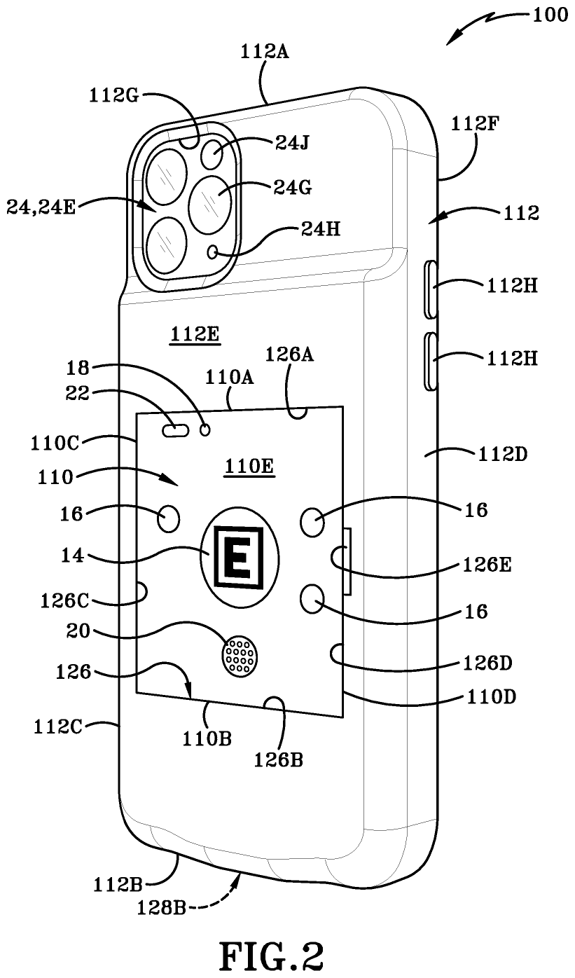

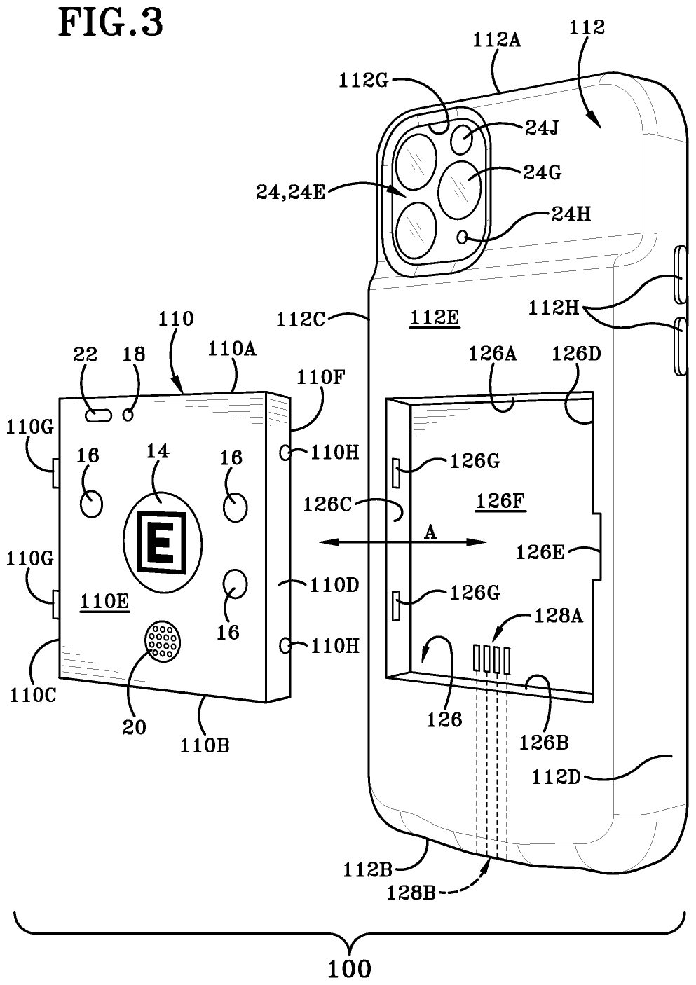

Referring now to FIGS. 2 and 3, in accordance with an aspect of the present disclosure, a second embodiment of case system is illustrated, generally indicated at 100. Case system 100 comprises a second embodiment of an assembly, generally indicated at 110 and a second embodiment of a case 112, and the same cell phone 24 as illustrated in FIG. 1A. Assembly 110 is engaged with case 112 which in turn is engaged around a portion of the exterior surface of cell phone 24. Assembly 110 will be described later herein

As best seen in FIG. 3, case 112 comprises a body having a top 112A spaced apart from a bottom 1126 and defining therebetween a vertical direction. Case 112 further has a right side 112C spaced apart from a left side 112D and defining therebetween a horizontal or transverse direction. Case 112 further includes a rear 112E spaced apart from a front 112F (FIG. 2) and defining therebetween the thickness of case 112. Case 112 may be ergonomically shaped along its top, bottom, and sides 112A, 112B, 112C, 112D so as to fit comfortably within the hand of a user.

Case 112 defines an aperture 112G therein which extends between rear 112E and front 112F. Aperture 112G is shaped and sized to be complementary to a region of cell phone 24 that includes camera 24G, microphone 24H, and LED 24J. The case 112 further included a plurality of projections 112H that are able to align with various buttons on cell phone 24.

In accordance with an aspect of the present disclosure, a cradle 126 is provided on the body of case 112. Cradle 126 is configured to house the assembly 110. Cradle 126, as illustrated, comprises a recess that is defined in case 112 and is accessible through an opening defined in rear 12E of case 112. (The terms “cradle 126” and “recess 126” may be used interchangeably herein) An interior surface of the case 112 which defines the recess 126 includes a top wall 126A, a bottom wall 126B, a right side wall 126C, a right side wall 126D that includes a notch 126E, and a front wall 126F. The interior surface defined by walls 126A through 126F bounds and defines the recess 126 and is complementary to a portion of an exterior surface of assembly 110 as will be discussed later herein. Apertures 126G are defined in right side wall 126C of case 112. The notch 126E and the apertures 126G are used in the engagement of assembly 110 within cradle 126 as will be described later herein. It will be understood that notch 126E and apertures 126G may be defined in any area of cradle 126 in order to enable assembly 110 to nest within cradle 126 and be secured therein. The specific locations of notch 126E and apertures 126G may differ from what is illustrated in FIG. 3.

The recess 126 defined in rear wall 112E of case 112 is generally square or rectangular in shape when case 112 is viewed from the back. It will be understood, however, that while cradle 126 is illustrated herein as being generally square when viewing the rear 12E of case 112, the recess 126 may be formed in any other desired location on case 112 and recess 126 may be of any desired configuration. For example, assembly 110 and cradle 126 may both be circular, triangular, or irregular in shape when viewed from the rear. Whatever shape of cradle 126 and assembly 110 is provided, the cradle 126 and assembly 110 are complementary to one another. Furthermore, the notch 126E may be provided in any location on any of the walls 126a through 126D. Assembly 110 that is to be received within cradle 126 will be complementary in size and shape to the recess 126 and is configured to be received within recess 126.

In accordance with a further aspect of the present disclosure, one or more charging and/or data pads 128A are provided on case 112. As illustrated, the charging and/or data pads 128A extend from a location on front wall 126F that bounds and defines recess 126 to interface/connect with charging node 1286 on case 112 or with a charging and/or data port (not shown) on the cell phone 24. The charging and/or data ports 128B on the bottom 112B of case 112 may be operatively engaged with a remote power source or remote data source and/or may communicate with the charging and/or data port on the cell phone 24. The charging and/or data pads 128A and ports 128B form part of the cradle 126 provided on case 112. The location and type of pad 128A is merely exemplary and other embodiments could be used depending on the desired implementation. Alternatively, the at least one charging and/or data pad 128A may only connect to the remote power source rather than to the cell phone 24 or may only connect to the cell phone 24 rather than to the remote power source depending on the desired implementation.

Referring still to FIGS. 2 and 3, assembly 110 is illustrated. Assembly 110, as shown in FIG. 3, is shaped to be complementary to the recess 126 of case 112. Assembly 110 includes a top 110A, a bottom 110B, a right side 110C, a left side 110D, a rear 110E, and a front 110F. In assembly 110, top 110A is spaced apart from bottom 110B defining therebetween a vertical direction, the right side 110C is spaced apart from left side 110D defining therebetween a horizontal or transverse direction, and rear 110E is spaced apart from front 110F defining therebetween a thickness of the assembly 110. Top 11A, bottom 11B, right side 110C, left side 110D, and front 110F form an exterior surface of assembly 110 that is complementary in shape and size to the interior surface of cradle 126. Assembly 110 further includes at least one protrusion 110G on right side 110C and at least one engaging surface 110H on left side 110D of assembly 110. Protrusions 110G are located so as to be aligned with apertures 126G defined in cradle 126 of case 112 when assembly 110 is engaged with cradle 112. Engaging surface(s) 110H are located so as to be aligned with portions of the left side wall 126D of cradle 126 that are above and below the notch 126E. It will be understood that the location of the protrusions 110G and engaging surfaces 110H is complementary to the configuration of apertures 126G and surfaces of cradle 126. It will further be understood that protrusion(s) 110G and engaging surface(s) may be provided in any suitable location on the exterior surface of assembly 110 that will be received within complementary apertures 126C in cradle 126 or abut the interior surface of cradle 126, respectively, when assembly 110 is engaged with case 112. Furthermore, in one embodiment the engaging surface(s) 110H may each include a spring or other similar mechanism to enable the engaging surface 110H to flex and be held in static contact with the interior surface of cradle 126, thereby retaining the assembly 110 in tight contact with the cradle 126.

When assembly 110 is inserted into cradle 126 of case 112, protrusions 110G on assembly 110 are received in apertures 126G of cradle 126 and engaging surface 110H abut regions of left side wall 126D of cradle 126 so that assembly is tightly retained within cradle 126. In another embodiment, apertures may be provided on the assembly 110 and the projections for engagement in the apertures may be provided on the cradle 126. In yet another embodiment each of the assembly 110 and cradle 112 may include one or more projections and one or more complementary apertures. Similarly, engaging surfaces may be provided on cradle 126 for frictional engagement with regions of the exterior surface of the assembly 110 or each of the assembly 110 and cradle 126 may include some engaging surfaces and some regions that will be contacted by engaging surfaces of the other component. It will be understood that in yet other embodiments a different type of securement mechanism may be utilized to retain assembly 110 in cradle 126.

When assembly 110 is inserted into and secured within cradle 126 of case 112, rear 110E of assembly 110 is substantially flush with rear 112E of case 112. If at a later time, the user wishes to remove assembly 110 from cradle 112, a flat-tipped instrument, such as a flat-head screwdriver, may be inserted into notch 126E. The tip of the flat-tipped instrument will be brought into engagement with left side 110D of assembly 110 and pressure will be applied to the left side 110D in order to dislodge assembly 110 from its nesting position within cradle 126.

Referring still to FIGS. 2 and 3, the body of assembly 110, similar to the body of assembly 10, includes an emergency button 14, a multifunction button 16, a microphone 18, a speaker 20, and an indicator light 22. Emergency button 14, multifunction button 16, microphone 18, speaker 20, and/or indicator light 22 are integrated into assembly 110. These operational components can be interfaced in such a way that each of these components interacts with a processor within assembly 110. Furthermore, when assembly 110 is engaged within cradle 126 of case 112, and case 112 is engaged with cell phone 24, the operational components of device 110 interface with the components of cell phone 24. According to another aspect, any or all of the emergency button 14, multifunction buttons 16, microphone 18, speaker 20, and indicator light 22 may be provided at any desired location on assembly 110.

Each of the emergency button 14, and/or multifunction buttons 16 may be fabricated from a resilient material, such as a rubberized or plastic material that will impart sufficient flexibility to the buttons 14, 16 to allow depression thereof. When emergency button 14 or multifunction buttons 16 are depressed, an electronic circuit within assembly 110 is closed. In the case of the emergency button 14, in an identical manner to assembly 10, when button 14 is depressed, an emergency signal is generated and is sent to a remote emergency services operator to call for help. Emergency button 14 on assembly 110 may be is identical in structure and function to emergency button 14 on assembly 10. Buttons 14, and/or 16 may further be sealed to impart water-resistant or waterproof properties to assembly 110.

Emergency button, multifunction buttons 16, microphone 18, speaker 20, and indicator light 22 provided on assembly 110 are substantially identical to the emergency button 14, multifunction button 16, microphone 18, speaker 20, and indicator light 22 provided on assembly 10. As a consequence, these components will not be discussed in further detail with respect to their provision on assembly 110.

Although not illustrated in the attached figures, it will be understood that assembly 110 is provided with one or more charging and/or nodes that are located and configured to interact with the charging and/or data pads 128A provided in cradle 126 of case 112 and thereby with cell phone 24.

Having thus described the elements and components of case system 100, the operation and function thereof will now be discussed. With respect to FIG. 3, the assembly 110 is shown disengaged from the cradle 126 of the case 112. When the user acquires a new cell phone 24, he or she will engage the case 112 with that cell phone 24 by deforming and manipulating the component regions of the case 112 so that the front 112F of the case 112 will abut the rear 24E of cell phone 24, and the top, bottom and sides 112A through 112D of case 112 will wrap around the top, bottom, and sides 24A through 24D of cell phone 24. Prior to or after engaging case 112 with cell phone 24, the assembly 110 will be engaged in cradle 126 of case 112. This engagement is accomplished by placing assembly 110 in the cradle 126 of case 12 and engaging the provided securement mechanism of the projections 110G and apertures 126G and the engaging surfaces 110H and regions of left side wall 126d defining cradle 126. When assembly 110 is engaged with case 112, assembly 110 is paired with cell phone 24.

As described earlier herein, if an emergency occurs, the user of the cell phone 24 may depress the emergency button 14 on assembly 110, and thereby generate and send out an emergency signal to a remote emergency services dispatcher. The microphone 18 and speaker 20 will be actuated to enable two-way communication between the user of the cell phone 24 and the remote dispatcher. In some instances, the depressing of the emergency button 14 will activate the camera on the cell phone 24 and enable video communication between the user and another person, such as an emergency contact, located remote from the user. Alternatively, cell phone 24 may be activated to send out a group text to emergency contacts of the user.

If at a later time, the user decides to change their cell phone 24, then provided the original case 112 fits the new cell phone, the user may keep the assembly 110 engaged with their original case 112, remove the combined assembly 110 and case 112 from the original cell phone 24, and then engage the original case 112 (with assembly 110 attached) on the new cell phone. If, however, the original case 112 does not fit the new cell phone, the assembly 110 may be disengaged from the original case 112 and be quickly and easily engaged with a new case. The new case will then be engaged with the new cell phone and the assembly 110 will then be paired with the new cell phone. When assembly 110 is to be disengaged from the original case 112, the assembly 110 may be pried out of the case 112 or otherwise removed therefrom by placing a flat-tipped tool or other small member into the notch 126E in case 112 in order to assist in disengaging the assembly 110 from the cradle 126. Specifically, force may be applied with the tool to push the left side 110D of the assembly 110 away from interfacing with the left side 126D of the cradle 126. This disengagement may allow the at least one engaging surface 110H to no longer be in contact with the left side wall 126D of the cradle 126. The assembly 110 may then be rotate about the right side 110C thereof so that at least a portion of the assembly 110 extends beyond the rear 112E of the case 112. This rotation breaks any engagement between the at least one protrusion 110G on the right side 110C of the assembly 110 with the at least one aperture 126G provided in the right side wall 126C of the cradle 126. The assembly 110 may then be lifted out of the cradle 126. This removal of the assembly 110 from cradle 126 is indicated by arrow “A” in FIG. 3.

In a similar fashion, if the user simply wishes to change their original case 112 with a new case, the assembly 110 may be disengaged from the original case 112 and be quickly and easily engaged with the new case. The new case will then be engaged with the original cell phone 24 and the assembly 110 will, once again, be paired with the original cell phone 24.

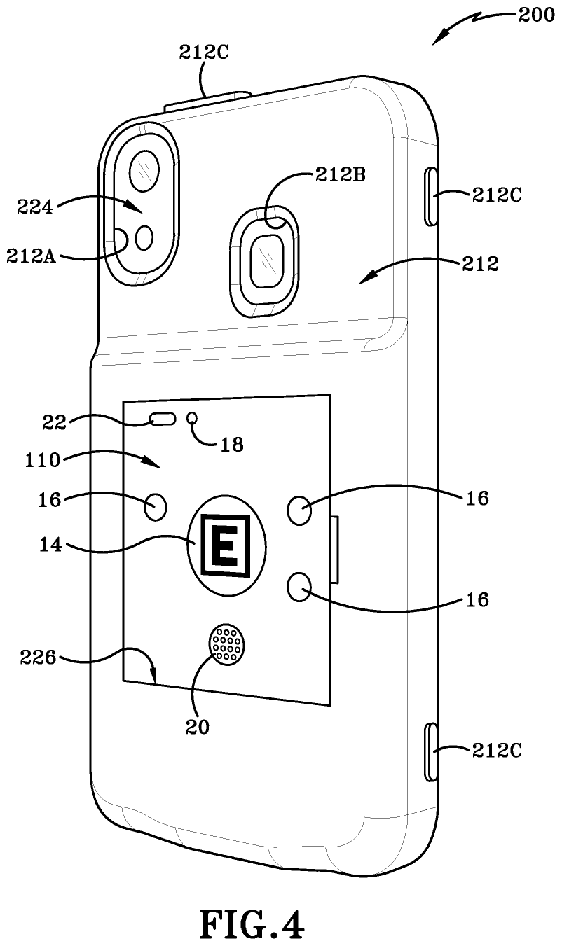

Referring now to FIG. 4, a third embodiment of a case system in accordance with an aspect of the present disclosure is shown, generally indicated at 200. The case system 200 includes a cell phone 224, a case 212, and the assembly 110.

Cell phone 224 is of a different configuration to the cell phone 24 illustrated in FIG. 1A and discussed earlier herein. The cell phone 224 is any known cell phone that provides a different arrangement of cameras, microphones, LEDs, buttons, and ports from cell phone 224. As a result of the differences between cell phone 224 and cell phone 24, the cases 12 and 112 will not be capable of being engaged with cell phone 224. Case 212 comprises a body that is configured to be engaged around a portion of the exterior surface of cell phone 224 and provides the various complementary components that will enable the operational components of cell phone 224 to be accessed and operated. By way of illustration only, case 212 defines a first aperture 212A and a second aperture 212B that will align with operational components on the cell phone 224. Additionally, case 212 includes projections 212C that will align with buttons (not shown) provided on cell phone 224. The specific configuration of cell phone 224 and the complementary case 212 are provided by way of example only.

In accordance with an aspect of the present disclosure, case 212 provides a cradle 226 that is configured to allow for engagement of an assembly therein. As indicated above the assembly that is to be engaged with cradle 226 is the assembly 110. Assembly 110 is the very same assembly 110 illustrated in FIGS. 2 and 3 and described above. Since assembly 110 is to be utilized in case system 200, cradle 226 will obviously have to be identical in configuration to cradle 126 provided on case 112 in order to receive assembly 110 therein. The provision of an identical cradle 226 on case 212 allows a user to change to a completely different cell phone 224 from their previous model, i.e., cell phone 24, but still utilize the peripheral device that they purchased for cell phone 24, i.e., their emergency assembly 110. In order to engage the assembly 110 with the case 212 and cell phone 224, the user will disengage the assembly 110 from case 112 as described earlier herein and will insert the removed assembly 110 into the cradle 226. When assembly 110 is fully engaged in the cradle 226, assembly 110 will pair with cell phone 224 and will be able to be used to generate and send an emergency signal as described earlier herein.

In other words, the removed assembly 110 has been reengaged with the new case 212 attached to a new cell phone 224. Therefore, a user of the assembly 110 may feel free to buy a completely different cell phone without needing to buy a new assembly 110. It will further be understood that if the user wished to use the assembly 110 on another internet-enabled device such as a laptop computer or an eBook reader, the case of the laptop computer or eBook reader would simply need to provide a cradle identical to cradle 126 (or 226) to make this possible. The user would disengage the assembly 110 from the case 112 (or 212) of their cell phone 24 (or 224), and then insert the assembly 110 into the cradle of the case for the laptop computer or eBook reader. The assembly 110 could then be utilized in the event of an emergency to send out a distress signal from the laptop computer or eBook reader. It will be understood that an identical cradle could be provided directly in the body of the laptop computer, eBook reader, cell phone, or any other internet-enabled device. In some embodiments, the internet-enabled device does not need to be portable. For example, a cradle could be formed into a housing for a smart TV. The provision of the cradle in such a TV housing would allow a user to engage the assembly 110 with the smart TV and use the same to generate and send out an emergency signal simply by depressing the emergency button 14 on the assembly 110.

In one embodiment, the case system could be a medical assembly 10 or 110. The medical assembly 10 or 110 may be utilized as a communication device in multiple ways. Firstly, medical assembly 110 may be utilized similar to current personal medical devices to contact emergency services via generation and transmission of an emergency services signal. In this mode, a user may depress emergency button 14 which may direct assembly 110 to send out an emergency signal via a cellular transceiver and/or an FM transceiver. The emergency signal may be generated and sent via the closest operable cellular or radio tower and may utilize the emergency wireless network to contact emergency services without the need for a subscription-based service, a cellular telephone plan, or an active internet connection. If assembly 10 or 110 is within range of any active cellular or radio tower, it may utilize this network to contact emergency services.

Secondly, medical assembly 10 or 110 may be utilized to connect with the cellphone 24 or 224 via a BLUETOOTH® transceiver or a short range NFC signal and enable the cell phone 24 or 224 to contact emergency services via an emergency services signal. In this mode, a user may depress emergency button 14 which may direct assembly 10 or 110 to send out an emergency signal via the BLUETOOTH® transceiver. The signal may be generated and recognized by the cell phone 24 or 224. The cell phone 24 or 224 will then relay the signal to a the closest operable cellular or radio tower and may utilize the emergency wireless network to contact emergency services without the need for a subscription-based service, a cellular telephone plan, or an active internet connection. If assembly 10 or 110 engagably coupled to the cell phone 24 or 224 is within range of any active cellular or radio tower, it may utilize this network to contact emergency services. Alternatively, if the cell phone 24 or 224 has an active cellular telephone plan, or an active internet connection, the emergency signal may pass from the assembly 10 or 110 to the cell phone 24 or 224 and to the emergency services this manner.

When in contact with emergency services, the microphone 18 and speaker 20 of assembly 10 or 110 may likewise be activated to allow a two-way communications connection with personnel at emergency services to allow the user to describe the nature of the emergency and/or where the user may be located. GPS on the cell phone 24 or 224 may also be activated to allow emergency services to locate the cell phone 24 or 224 and thereby locate the user.

In addition to the standard and current two-way audio connections, assembly 10 or 110 and the components thereof may further enable additional types of communication between the user of medical assembly 10 or 110 and others. A first additional communication may be a video connection directly to a predetermined emergency contact utilizing a camera 24G located on the cell phone 24 or 224. This video connection may be via video signal sent to a video contact from assembly 10 or 110 or via the cell phone 24 or 224 The video contact may be preprogrammed into assembly 10 or 110 and stored in the memory of a processor provided in assembly 10 or 110 such that when the emergency services button 14 is depressed, the emergency signal is sent to emergency services and, simultaneously, a video signal is sent to the emergency video contact. The video signal may be sent to the emergency video contact via one or more of cellular transceiver, BLUETOOTH® transceiver, and/or FM transceiver.

According to one aspect, assembly 10 or 110, if connected to a wireless internet connection, may generate a wireless signal via FM transceiver and may utilize the wireless internet connection to transmit the video signal to video contact. Simultaneously, the camera 24G of the cell phone 24 or 224 may be activated along with microphone 18 and speaker 20 of assembly 10 or 110 (and/or the microphone and speaker provided on cell phone 24 or 224) to allow the video contact to view whatever the camera sees via a live video feed while having a two-way audio connection with the user of assembly 10 or 110. If an internet connection is not available to assembly 10 or 110, the video signal may be sent via an active cellular subscription plan either directly, utilizing cellular transceiver, or indirectly such as through a BLUETOOTH® connection with a nearby cellular device via BLUETOOTH® transceiver. In this instance, the video signal will still be generated to video contact while activating the camera of the cell phone 24 or 224, and microphone 18 and speaker 20 of assembly 10 or 110 in the same manner as if sent over internet connection. Where no subscription cellular plan or internet connection is available, assembly 10 or 110 may still contact emergency services via emergency signal as discussed previously herein.

Another communications method enabled by assembly 10 or 110 may include a group text messaging signal sent by assembly 10 or 110 (or via cell phone 24 or 224) to a group of contacts stored in the memory of assembly 10 or 110 or a memory of cell phone 24 or 224. According to this aspect, when emergency button 14 is depressed, assembly 10 or 110 may simultaneously send the emergency signal and video signal as discussed previously herein, but may also generate a group text messaging signal which may be sent directly to an emergency contact group. The group messaging signal may be a preselected or a preset short messaging service (SMS) message and/or multimedia messaging service (MMS) message which may be sent out via cellular transceiver if connected to an active cellular subscription plan, via BLUETOOTH® transceiver by way of a secondary cellular device as described with video signal, and/or via an active internet connection as also described with reference to video signal. Similarly, the assembly 10 or 110 could use the components of the cell phone 24 or 224 independent of the assembly 10 or 110 components other than providing an initial connection. According to one aspect, assembly 10 or 110 may send an emergency message to the group contacts indicating that an emergency has occurred and providing further instructions. As with video signal, where an internet connection and/or an active cellular data connection are not available, assembly 10 or 110 may still contact emergency services via emergency signal. According to another aspect, assembly 10 or 110 may send a message to the phone 24 or 224 which in turn sends an emergency message to the group contacts indicating that an emergency has occurred and providing further instructions. As with video signal, where an internet connection and/or an active cellular data connection are not available, assembly 10 or 110 may still contact emergency services via emergency signal.

Furthermore, a user may change the case 12, 112, 212 for aesthetic reasons. The user may desire not to change the expensive cell phone but instead the less expensive case while keeping the assembly 10 or 110. Therefore, a user could buy an additional case or a series of cases for their cell phone 24 or 224 and change the color of the case to coordinate with an outfit, or to change the look of the case in other ways. Some of these ways may be to include more of an ergonomic grip to allow the phone to be easier to grasp for arthritic hands. Further, the case may be outfitted with identifying indicia, logos, or further information to allow the case to stand out to its owner or caretaker.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “element A and/or element B”, when used in conjunction with open-ended language such as “comprising” can refer, in one embodiment, to element A only (optionally including elements other than element B); in another embodiment, to element B only (optionally including elements other than element A); in yet another embodiment, to both element A and element B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A case system comprising:
a body adapted to be engaged with an internet-enabled device;
a cradle provided on the body; and
an assembly selectively removably engageable with the cradle;
wherein the assembly is actuatable to send an emergency signal to an emergency services dispatcher located remote from a user of the case system.

2. The case system of claim 1, wherein the internet-enabled device is a portable device, and wherein the portable device comprises one of a cell phone, a tablet, a smart watch, a Personal Digital Assistant (PDA), a laptop computer, an eBook reader, and a gaming console.

3. The case system of claim 1, wherein the body comprises a case configured to be engaged around at least a portion of an exterior surface of the internet-enabled device.

4. The case system of claim 1, wherein the assembly is electronically paired to the internet-enabled device.

5. The case system of claim 4, wherein the assembly, when activated, is operable to generate and send the emergency signal via a wireless network.

6. The case system of claim 1, wherein the assembly includes a depressible emergency button.

7. The case system of claim 1, wherein the assembly includes one or more of a microphone, a speaker, a multi-function button, and an indicator light.

8. A method comprising:
engaging a first body with a first portable device;
engaging an assembly with a first cradle provided on the first body; wherein the assembly is actuatable to send an emergency signal to a remote emergency services dispatcher;
removing the assembly from the first cradle;
providing a second cradle on a second body; and
engaging the assembly with the second cradle.

9. The method of claim 8, wherein engaging the first body with the first portable device includes engaging the first body with an internet-enabled first portable device.

10. The method of claim 9, further comprising electronically pairing the assembly with the internet-enabled first portable device.

11. The method of claim 10, engaging the second body with an internet-enabled second portable device.

12. The method of claim 11, further comprising electronically pairing the assembly with the internet-enabled second portable device.

13. The method of claim 12, wherein providing each of the internet-enabled first portable device and the internet-enabled second portable device comprises selecting one of a cell phone, a tablet, a smart watch, a Personal Digital Assistant (PDA), a laptop computer, an eBook reader, and a gaming console.

14. The method of claim 8, wherein engaging the first body with the first portable device includes covering at least a portion of an exterior surface of the first portable device with the first body.

15. The method of claim 11, wherein engaging the second body with the second portable device includes covering at least a portion of an exterior surface of the second portable device with the second body.

16. The method of claim 11, further comprising providing the second portable device in a different configuration from a configuration of the first portable device.

17. The method of claim 8, further comprising:
connecting the assembly to the first portable device via a wired or wireless connection.

18. The method of claim 12, further comprising:
connecting the assembly to the second portable device via a wired or wireless connection.

19. The method of claim 8, further comprising:
depressing an emergency button provided on the assembly;
generating and sending the emergency signal to the remote emergency services dispatcher.

20. The method of claim 19, further comprising:
actuating one or more of a microphone, a speaker, and an indicator light.
